(19) United States
(12) Patent Application Publication
(10) Pub. No.: US 2024/0096312 A1
(43) Pub. Date: Mar. 21, 2024

(54) SYSTEM AND METHOD FOR ADAPTIVELY TRAVERSING CONVERSATION STATES USING CONVERSATIONAL Al TO EXTRACT CONTEXTUAL INFORMATION

(71) Applicant: Babblebots Inc, Palo Alto, CA (US)

(72) Inventors: Roli Gupta, Mumbai (IN); Hrishikesh Deshpande, Mumbai (IN); Janardhan Singh, Thane ( W ) (IN); Dhruv Jaglan, Zirakpur (IN)

(21) Appl. No.: 18/369,088

(22) Filed: Sep. 15, 2023

(30) Foreign Application Priority Data
Sep. 15, 2022 (IN) 202241052867

(51) Int. Cl. G10L 15/06; G10L 15/183; G10L 15/32

(52) U.S. Cl. CPC G10L 15/063; G10L 15/183; G10L 15/32

(57) ABSTRACT

Embodiments herein provide a method for adaptively traversing conversation states using conversational AI to extract contextual information. The method includes (i) loading states that define a logical flow of the automated conversation and comprises a content boundary, (ii) dynamically generating a first question associated with the first conversation state by obtaining a prompt, (iii) determine whether a first response is inside or outside of the content boundary, (iv) generating in real-time a first follow-up question by (a) determining a missing content, or (b) analyzing the resume of the user, job description, (v) monitoring a second response to extract a skill level of the user, (vi) automatically computing possible paths of the conversation to obtain an updated N subsequent conversation states of the conversation, (vii) generating a second follow-up question; and (viii) repeating generating follow-up questions for adaptively traversing the N updated conversation states.

### BACKGROUND

### Technical Field

The embodiments herein relate to the field of conversational artificial intelligence, and more specifically to a system and method for adaptively traversing conversation states using conversational AI to extract contextual information.

### Description of the Related Art

In the field of conversational artificial intelligence (AI) systems, a significant technical problem has persisted in the conventional approach to automated conversations between AI bots and users. Existing conversational AI systems primarily rely on predefined scripts and pathways that, while effective for certain user types or specific contexts, often fall short in capturing contextually relevant information for a broader range of users. This limitation results in various adverse consequences, including increased conversation duration and the potential need for repeated interactions. Therefore, the traditional systems have an inability to effectively extract contextually relevant information from user responses.

Additionally, the nature of user responses in automated conversations is unpredictable. Users may provide incomplete information, respond ambiguously, or change the topic from the expected conversation pathway or context, making it even more challenging for traditional conversational AI systems to capture contextual information effectively. In this case, the traditional conversational AI systems struggle to adapt and may continue to follow an irrelevant or unproductive conversational pathway. As a result, the traditional conversational AI systems fail to capture contextual information.

Accordingly, there remains a need to address the technical problem of adaptively traversing conversation states in conversational AI to extract contextual information from the user.

### SUMMARY OF THE INVENTION

In view of the foregoing, embodiments herein provide a processor-implemented method for adaptively traversing conversation states using conversational AI to extract contextual information. The method includes (1) loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation, (2) dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description, (3) monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state, (4) generating in real-time, at the conversation server using the at least one custom ML model and the LLM, a first follow-up question by performing one of: (a) determining a missing content in the first response using the at least one domain-specific ML model associated with the job-description, if the first response is outside the content boundary of the first conversation state, to redirect the user to the first conversation state with the first follow-up question, or (b) analyzing at least one of (i) the resume of the user, (ii) the job description with the at least domain-specific ML model associated with the job-description, if the first response is inside the content boundary of the first conversation state, to direct the user to a first subsequent state with the first follow-up question, (5) monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user, (6) automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user, (7) generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation, and (8) repeating generating follow-up questions for the artificially intelligent bot in real-time at the conversation server using the custom ML model and the LLM for adaptively traversing the N updated conversation states between the user and the artificially intelligent bot to extract contextual information.

The method is of advantage that the method optimizes retrieval of contextual information during automated conversations between users and artificially intelligent bots by dynamically updating conversation states. The method utilizes content boundary to monitor responses of the user in real-time and detect when the user provides incomplete information, responds ambiguously, or changes the topic. When such instances are detected, the custom machine learning models generate follow-up questions in real-time that guide the user back to the intended question or topic.

Further, the method is of advantage that the method minimizes latency in automated conversations. By integrating general-purpose Large Language Models (LLMs) with custom ML models, the method optimally combines the strengths of both. The method enables rapid and contextually precise computation of possible conversation paths at each user response. By utilizing the custom ML models, the method computes possible paths of the conversation to dynamically update the conversation states, thus eliminating unnecessary detours and maximizing retrieval of contextual information from the user. The result is an efficient automated conversation that takes less time to retrieve contextual information from the user and enhances efficiency and effectiveness of conversational AI driven interactions.

In some embodiments, the method includes re-training the at least one custom ML model by (i) tagging content data associated with the responses, and (ii) improving a classification threshold by identifying a pattern in the content of the user using unsupervised learning to re-train the at least one custom ML models.

In some embodiments, the method includes evaluating the user on a plurality of parameters associated with the skills of the user by extracting at least one of a contextual feature or a vocal feature from responses provided by the user, wherein the plurality of parameters comprises at least one of a response duration parameter, a sentiment parameter, a personality parameter, a meaningfulness parameter, a grammar parameter, a filler word usage parameter, or a monosyllabic answer parameter.

In some embodiments, the method includes enabling the user to practice the automated conversation, wherein the processor generates new follow-up questions based on the first response provided by the user for the first question.

In some embodiments, the method includes simulating the automated conversation based on (a) a selected job description that is selected by the user from a list of job descriptions and (b) a resume provided by the user.

In some embodiments, the method includes monitoring a response to a theoretical question by providing content of a standard answer to at least one custom ML model.

In some embodiments, the method includes monitoring a response to a work experience related question by providing (a) a project detail from the resume, and (b) a template of questions associated with a role associated with the automated interview.

In one aspect, a system for adaptively traversing conversation states using conversational AI to extract contextual information is provided. The system includes a memory that stores a set of instructions and a processor that is configured to execute the set of instructions. The processor is configured to (1) loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation, (2) dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description, (3) monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state, (4) generating in real-time, at the conversation server using the at least one custom ML model and the LLM, a first follow-up question by performing one of: (a) determining a missing content in the first response using the at least one domain-specific ML model associated with the job-description, if the first response is outside the content boundary of the first conversation state, to redirect the user to the first conversation state with the first follow-up question, or (b) analyzing at least one of (i) the resume of the user, (ii) the job description with the at least domain-specific ML model associated with the job-description, if the first response is inside the content boundary of the first conversation state, to direct the user to a first subsequent state with the first follow-up question, (5) monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user, (6) automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user, (7) generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation, and (8) repeating generating follow-up questions for the artificially intelligent bot in real-time at the conversation server using the custom ML model and the LLM for adaptively traversing the N updated conversation states between the user and the artificially intelligent bot to extract contextual information.

The system is of advantage that the system optimizes retrieval of contextual information during automated conversations between users and artificially intelligent bots by dynamically updating conversation states. The system utilizes content boundary to monitor responses of the user in real-time and detects when the user provides incomplete information, responds ambiguously, or changes the topic. When such instances are detected, the custom machine learning models generate follow-up questions in real-time that guide the user back to the intended question or topic.

Further, the system is of advantage that the system minimizes latency in automated conversations. By integrating general-purpose Large Language Models (LLMs) with custom ML models, the system optimally combines the strengths of both. The system enables rapid and contextually precise computation of possible conversation paths at each user response. By utilizing the custom ML models, the system computes possible paths of the conversation to dynamically update the conversation states, thus eliminating unnecessary detours and maximizing retrieval of contextual information from the user. The result is an efficient automated conversation that takes less time to retrieve contextual information from the user and enhances efficiency and effectiveness of conversational AI driven interactions.

In some embodiments, the processor is configured to perform re-training the at least one custom ML model by (i) tagging content data associated with the responses, and (ii) improving a classification threshold by identifying a pattern in the content of the user using unsupervised learning to re-train the at least one custom ML models.

In some embodiments, the processor is configured to perform evaluating the user on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter.

In some embodiments, the processor is configured to perform enabling the user to practice the automated conversation, wherein the processor generates new follow-up questions based on the first response provided by the user for the first question.

In some embodiments, the processor is configured to perform simulating the automated conversation based on (a) a selected job description that is selected by the user from a list of job descriptions and (b) a resume provided by the user.

In some embodiments, the processor is configured to perform monitoring a response to a theoretical question by providing content of a standard answer to at least one custom ML model.

In some embodiments, the processor is configured to perform monitoring a response of a work experience related question by providing (a) a project detail from the resume, and (b) a template of questions associated a role associated with the automated interview.

In another aspect, a non-transitory computer-readable storage medium storing a sequences of instructions, which when executed by one or more processors, causes for adaptively traversing conversation states using conversational AI to extract contextual information by (1) loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation, (2) dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description, (3) monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state, (4) generating in real-time, at the conversation server using the at least one custom ML model and the LLM, a first follow-up question by performing one of: (a) determining a missing content in the first response using the at least one domain-specific ML model associated with the job-description, if the first response is outside the content boundary of the first conversation state, to redirect the user to the first conversation state with the first follow-up question, or (b) analyzing at least one of (i) the resume of the user, (ii) the job description with the at least domain-specific ML model associated with the job-description, if the first response is inside the content boundary of the first conversation state, to direct the user to a first subsequent state with the first follow-up question, (5) monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user, (6) automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user, (7) generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation, and (8) repeating generating follow-up questions for the artificially intelligent bot in real-time at the conversation server using the custom ML model and the LLM for adaptively traversing the N updated conversation states between the user and the artificially intelligent bot to extract contextual information.

In some embodiments, the one or more non-transitory computer-readable storage mediums storing the one or more sequences of instructions, which when executed by the one or more processors further causes re-training the at least one custom ML model by (i) tagging content data associated with the responses, and (ii) improving a classification threshold by identifying a pattern in the content of the user using unsupervised learning to re-train the at least one custom ML models.

In some embodiments, the one or more non-transitory computer-readable storage mediums storing the one or more sequences of instructions, which when executed by the one or more processors further causes evaluating the user on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter.

In some embodiments, the one or more non-transitory computer-readable storage mediums storing the one or more sequences of instructions, which when executed by the one or more processors further causes enabling the user to practice the automated conversation, wherein the processor generates new follow-up questions based on the first response provided by the user for the first question.

In some embodiments, the one or more non-transitory computer-readable storage mediums storing the one or more sequences of instructions, which when executed by the one or more processors further causes simulating the automated conversation based on (a) a selected job description that is selected by the user from a list of job descriptions and (b) a resume provided by the user.

In some embodiments, the one or more non-transitory computer-readable storage mediums storing the one or more sequences of instructions, which when executed by the one or more processors further causes monitoring a response to a theoretical question by providing content of a standard answer to at least one custom ML model.

In some embodiments, the one or more non-transitory computer-readable storage mediums storing the one or more sequences of instructions, which when executed by the one or more processors further causes monitoring a response of a work experience related question by providing (a) a project detail from the resume, and (b) a template of questions associated a role associated with the automated interview.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof; and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system for adaptively traversing conversation states using conversational AI to extract contextual information according to some embodiments herein;

FIG. 2 is a block diagram of the conversational server of FIG. 1 according to some embodiments herein;

FIG. 3 is an exemplary view of layers of models used for generating follow-up questions according to some embodiments herein;

FIGS. 4A-4C are user interfaces that illustrate a first automated conversation between the artificially intelligent bot and a first user with according to some embodiments herein;

FIG. 5 is a user interface that illustrates a second automated conversation between the artificially intelligent bot and a second user according to some embodiments herein;

FIG. 6 is an exemplary view of an evaluation report a user according to some embodiment herein;

FIGS. 7A and 7B are flow diagrams of a method for adaptively traversing conversation states using conversational AI to extract contextual information according to some embodiments herein; and

FIG. 8 is a schematic diagram of a computer architecture of the subset deriving server or one or more entity devices in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

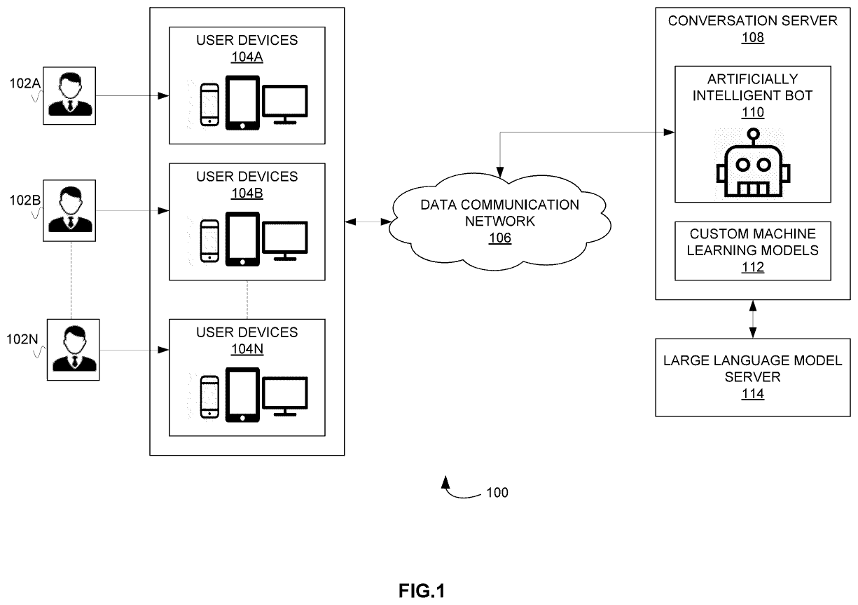

There remains a need for a system and method for adaptively traversing conversation states using conversational AI to extract contextual information. Referring now to the drawings, and more particularly to FIGS. 1 to 8, where similar reference characters denote corresponding features consistently throughout the figures, there are shown preferred embodiments.

The term “artificially intelligent bot” refers to a computer program or software application equipped with artificial intelligence capabilities, designed to simulate human-like interactions and responses in a conversational context. The artificially intelligent bot is enabled to understand and generate natural language, enabling automated communication with users.

The term “automated conversation” refers to a dialogue between a human user and a computer program or artificially intelligent bot, where responses and questions are generated and managed automatically, based on conversation states.

The term “content boundary” refers to a predefined limit that demarcates the scope of acceptable content, questions, or responses within a conversation. It serves as a control mechanism to ensure that interactions stay within predefined parameters.

The term “conversation states” refers to distinct phases or stages within a conversation, each representing a specific point in the interaction. Conversation states enable organizing a flow of the automated conversation and define the context for generating questions and responses.

The term “possible paths of conversation” refers to various routes or trajectories that a conversation can take during an interaction. These paths encompass different combinations of questions, responses, and follow-up queries that can occur based on user input and system rules.

The term “contextual information” refers to information that is relevant and dependent on the specific circumstances, environment, or conditions within a given situation or conversation. Contextual information is essential for understanding and responding appropriately to user queries or inputs in a conversation.

FIG. 1 is a block diagram of a system 100 for adaptively traversing conversation states using conversational AI to extract contextual information according to some embodiments herein. The system 100 includes one or more entity devices 104A-N associated with one or more users 102A-N. In some embodiments, the one or more entity devices 104A-N include but are not limited to, a mobile device, a smartphone, a smartwatch, a notebook, a Global Positioning System (GPS) device, a tablet, a desktop computer, a laptop or any network-enabled device that generates the location data streams. The one or more entity devices 104A-N are communicatively connected to a conversation server 108 through a network 106. In some embodiments, the network 106 is a wired network. In some embodiments, the network 106 is a wireless network. In some embodiments, the network 106 is a combination of the wired network and the wireless network. In some embodiments, network 106 is the Internet.

The conversation server 108 is connected to a large language model server 114. The conversation server 108 includes an artificially intelligent bot 110 and a custom machine learning models 112.

The conversation server 108 is configured to load a plurality of conversation states from a custom database based on a request received from a user device 102 A for an automated conversation with the artificially intelligent bot 110. The plurality of conversation states defines a logical flow of the automated conversation and include a first conversation state and N subsequent conversation states (where N is a positive integer greater than 1). Each of the plurality of conversation states comprises a content boundary that demarcates a scope of acceptable questions and responses in the conversation.

The conversation server 108 dynamically generates a first question associated with the first conversation state by obtaining a prompt for a large language model (LLM) at the large language model server 114. The prompt is obtained by analyzing one or more of (i) a resume of the user, or (ii) a job description associated with the automated conversation with one or more domain-specific ML models associated with the job-description. The conversation server 108 monitors in real-time, using the custom ML models 112 with the content boundary, a first response provided by the user 102A to the first question asked by the artificially intelligent 110 bot at the user device 104A, to determine whether the first response is inside or outside of the content boundary associated with the first conversation state.

The conversation server 108 generates in real-time, using the custom ML models 112 and the LLM, a first follow-up question by performing one of: (a) determining a missing content in the first response using the at least one domain-specific ML model associated with the job-description, if the first response is outside the content boundary of the first conversation state, to redirect the user 102A to the first conversation state with the first follow-up question, or (b) analyzing at least one of (i) the resume of the user 102A, (ii) the job description with the at least domain-specific ML model associated with the job-description, if the first response is inside the content boundary of the first conversation state, to direct the user 102A to a first subsequent state with the first follow-up question.

The conversation server 108 monitors in real-time, using the custom ML models 112 and the LLM with the content boundary, a second response provided by the user 102A to the first follow-up question asked by the artificially intelligent bot 110 at the user device 104A, to (a) determine whether the second response is inside or outside of the content boundary associated with the first subsequent state and (b) extract a skill level of the user.

The conversation server 108 automatically computes possible paths of the conversation using the custom ML models 112 and the LLM with the second response to obtain an updated N subsequent conversation states of the conversation. The updated N subsequent conversation states optimize contextual information retrieval from the user 102A in the automated conversation based on the skill level of the user 102A. The conversation server 108 generates in real-time, using the custom ML models 112 and the LLM, a second follow-up question by analyzing at least one of (i) the resume of the user 102A, (ii) the job description, and (iii) the updated N subsequent conversation states with the custom ML models 112 and the LLM, to direct the user 102A to the updated N subsequent conversation states of the conversation.

The conversation server 108 repeats generating follow-up questions for the artificially intelligent bot 110 in real-time using the custom ML models 110 and the LLM for adaptively traversing the N updated conversation states between the user 102A and the artificially intelligent bot 110 to extract contextual information.

The system 100 is of advantage that the system 100 optimizes retrieval of contextual information during automated conversations between users and artificially intelligent bots by dynamically updating conversation states. The system 100 utilizes content boundary to monitor responses of the user in real-time and detect when the user provides incomplete information, responds ambiguously, or changes the topic. When such instances are detected, the custom machine learning models generate follow-up questions in real-time that guide the user back to the intended question or topic.

Further, the system 100 is of advantage that the system 100 minimizes latency in automated conversations. By integrating general-purpose Large Language Models (LLMs) with custom ML models, the system 100 optimally combines the strengths of both. The system 100 enables rapid and contextually precise computation of possible conversation paths for each user response. By utilizing the custom ML models, the system 100 computes possible paths of the conversation to dynamically update the conversation states, thus eliminating unnecessary detours and maximizing retrieval of contextual information from the user. The result is an efficient automated conversation that takes less time to retrieve contextual information from the user and enhances efficiency and effectiveness of conversational AI driven interactions.

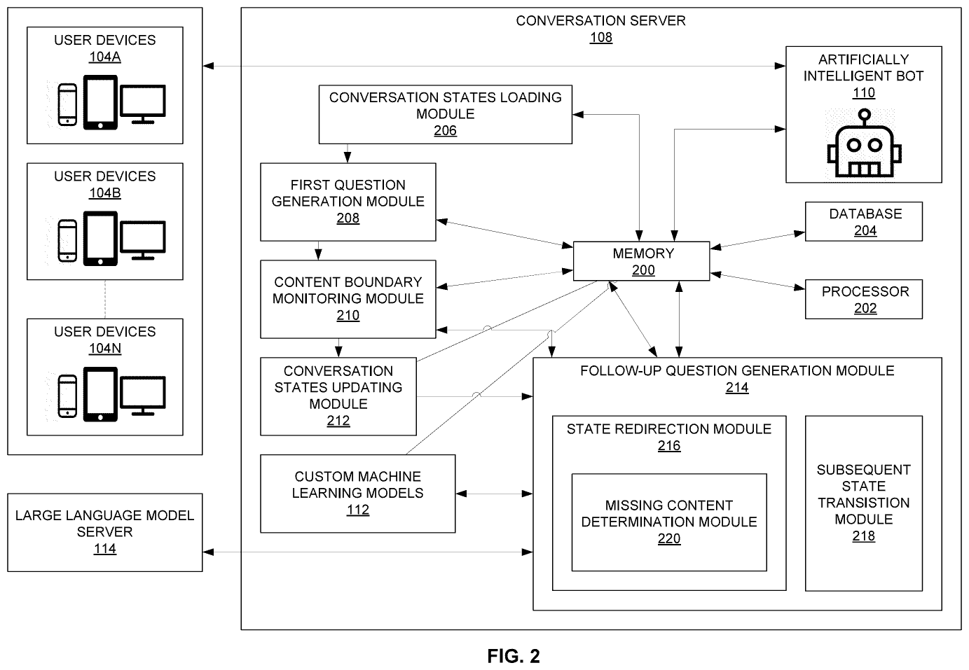

FIG. 2 is a block diagram of the conversational server 108 of FIG. 1 according to some embodiments herein. The server 108 includes a database 202, a feature selection module 204, an elements partitioning module 206, a first set of elements labeling module 208, the category specific AI model 110, a proclivity score determining module 210, and a subset of entities or place deriving module 212. The database 202 stores the category and the dataset.

The conversation states loading module 206 loads a plurality of conversation states from a custom database based on a request received from a user device 102 A for an automated conversation with the artificially intelligent bot 110. The plurality of conversation states defines a logical flow of the automated conversation and include a first conversation state and N subsequent conversation states (where N is a positive integer greater than 1). Each of the plurality of conversation states comprises a content boundary that demarcates a scope of acceptable questions and responses in the conversation.

The first question generation module 208 dynamically generates a first question associated with the first conversation state by obtaining a prompt for a large language model (LLM) at the large language model server 114. The prompt is obtained by analyzing one or more of (i) a resume of the user, or (ii) a job description associated with the automated conversation with one or more domain-specific ML models associated with the job-description.

In some embodiments, the conversation server 108 leverages generalized LLMs to handle various conversation contexts. The LLMs are provided with context specific to the automated conversation. For instance, if a technical question is generated and the response of the user lacks essential content, the missing content determination module 220 detects missing content and generates follow-up questions.

The content boundary monitoring module 210 monitors in real-time, using the custom ML models 112 with the content boundary, a first response provided by the user 102A to the first question asked by the artificially intelligent 110 bot at the user device 104A, to determine whether the first response is inside or outside of the content boundary associated with the first conversation state.

In some embodiments, the large language model server 114 includes generic AI Models, such as Google's Farm, ChatGPT, and OpenAI's DaVinci. These models operate at a similar level, effectively generating questions in real-time for deeper insights based on the context provided along with the custom machine learning models 112 for decision-making and post-response analysis, thereby optimizing the flow of the automated conversation to maximize retrieval of contextual information.

The follow-up question generation module 214 generates in real-time, using the custom ML models 112 and the LLM, a first follow-up question by performing one of: (a) determining, using the missing content determination module 220, a missing content in the first response using the at least one domain-specific ML model associated with the job-description, if the first response is outside the content boundary of the first conversation state, to redirect the user 102A to the first conversation state with the first follow-up question, or (b) analyzing, using the subsequent state transition module 218, at least one of (i) the resume of the user 102A, (ii) the job description with the at least domain-specific ML model associated with the job-description, if the first response is inside the content boundary of the first conversation state, to direct the user 102A to a first subsequent state with the first follow-up question.

The content boundary monitoring module 210 monitors in real-time, using the custom ML models 112 and the LLM with the content boundary, a second response provided by the user 102A to the first follow-up question asked by the artificially intelligent bot 110 at the user device 104A, to (a) determine whether the second response is inside or outside of the content boundary associated with the first subsequent state and (b) extract a skill level of the user.

The conversation states updating module 212 automatically computes possible paths of the conversation using the custom ML models 112 and the LLM with the second response to obtain an updated N subsequent conversation states of the conversation. The updated N subsequent conversation states optimize contextual information retrieval from the user 102A in the automated conversation based on the skill level of the user 102A. Each model within the custom machine learning models 112 is customized for different skills, such as sales negotiation, and each module is provided with a specific context. These contexts enable guiding the custom machine learning models 112 in generating relevant questions and responses that enables contextually precise computation of conversation paths.

In some embodiments, if the content boundary monitoring module 210 identifies that the user 102A has answered a question correctly, it adapts by asking more challenging or deeper questions. Conversely, if a response of the user 102A falls short, the conversation states updating module 212 adjusts the updated N subsequent conversation states accordingly, thereby increasing the efficiency of retrieval of contextual information of the user.

The follow-up question generation module 214 generates in real-time, using the custom ML models 112 and the LLM, a second follow-up question by analyzing at least one of (i) the resume of the user 102A, (ii) the job description, and (iii) the updated N subsequent conversation states with the custom ML models 112 and the LLM, to direct the user 102A to the updated N subsequent conversation states of the conversation.

The follow-up question generation module 214 repeats generating follow-up questions for the artificially intelligent bot 110 in real-time using the custom ML models 110 and the LLM for adaptively traversing the N updated conversation states between the user 102A and the artificially intelligent bot 110 to extract contextual information.

In some embodiments, the at least one custom ML model is re-trained by (i) tagging content data associated with the responses, and (ii) improving a classification threshold by identifying a pattern in the content of the user using unsupervised learning to re-train the at least one custom ML models.

In some embodiments, the user is evaluated on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter. For questions with a fixed correct answer, a predefined criterion is used. For open-ended questions, the plurality of parameters are identified. The one or more users 102A-N receive different scores based on the number of parameters they address in their responses.

The effectiveness of the conversation server 108 depends on the context provided to the custom machine learning models 112. While some aspects of the conversation server 108 rely on generalized LLMs, the custom machine learning models 112 are developed for specific decision-making, ensuring low latency. Examples include English Proficiency Confidence and technical and non-technical assessments, which are performed by in-house models designed for entity detection and pre-processing.

In some embodiments, the method includes enabling the user to practice the automated conversation, wherein the processor generates new follow-up questions based on the first response provided by the user for the first question.

In some embodiments, the method includes simulating the automated conversation based on (a) a selected job description that is selected by the user from a list of job descriptions and (b) a resume provided by the user.

In some embodiments, the method includes monitoring a response to a theoretical question by providing content of a standard answer to at least one custom ML model.

In some embodiments, the method includes monitoring a response of a work experience related question by providing (a) a project detail from the resume, and (b) a template of questions associated with a role associated with the automated interview.

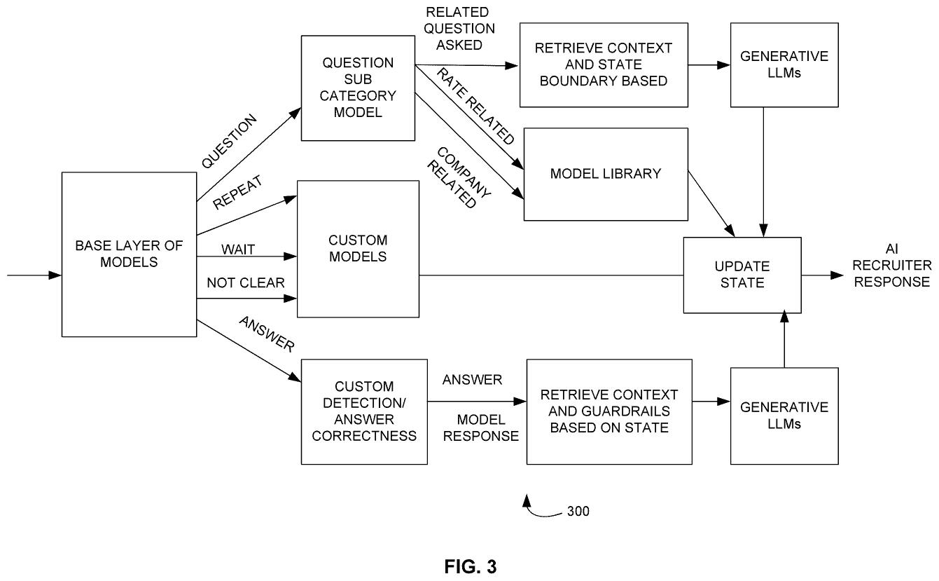

FIG. 3 is an exemplary view of layers of models used for generating follow-up questions according to some embodiments herein. A base layer of models with question sub category model, custom models, custom detection/answer correctness is illustrated. Further, state updated and usage of generative LLMs is illustrated.

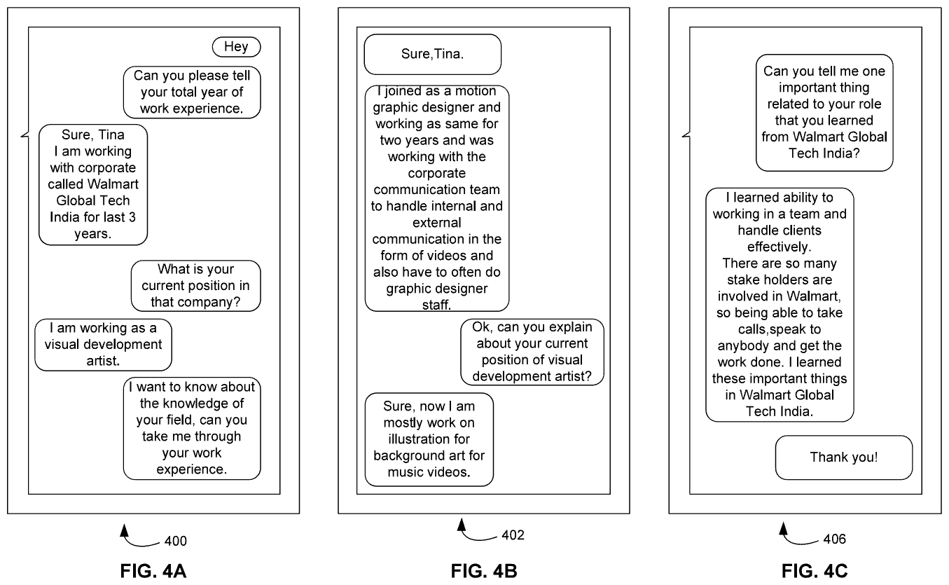

FIGS. 4A-4C are user interfaces that illustrate a first automated conversation between the artificially intelligent bot and a first user 102A with according to some embodiments herein. In the user interface (UI) 400, the artificially intelligent bot named “Tina” dynamically generates the first question associated with the first state and initiates the conversation with the user 102 by providing greetings and a first question. The question is generated using a prompt obtained by analyzing at least one of the resume of the user 102A or the job description associated with the automated conversation. The user 102 responds to the first question with information about their current workplace. The artificially intelligent bot analyzes this response in real-time, to determine whether the response is inside or outside of the content boundary associated with the first state. In this case, the response remains within the content boundary.

Based on the response, the artificially intelligent bot generates a follow-up question, directing the conversation to the next state based on the response being inside the content boundary. The question asked is “What is your current position?”. The user 102A provides their current position, “I am working as a visual development artist.” The artificially intelligent bot analyzes this response and generates a question relevant to the position of the user.

In the UI 402 of FIG. 4B, the artificially intelligent bot generates a follow-up question based on the context and content of the user's previous response: “Ok, can you explain about your current position of visual development artist?” This corresponds to the claim's step (7), where the system. The user 102A responds with, “Sure, now I am mostly working on illustration for background art for music videos.” The artificially intelligent bot, in real-time, analyzes this response, which is within the content boundary, and proceeds with generating a follow-up question.

In the UI 406 of FIG. 4C, the artificially intelligent bot generates another follow-up question, “Can you tell me one important thing related to your role that you learned from Walmart Global Tech India?”. The user 102A responds with insights gained from their role, “I learned the ability to work in a team and handle clients effectively . . . ” The artificially intelligent bot, following analyzes this response for context and content. Based on this analysis, it generates a closing message to end the conversation, which corresponds to the claim's step.

The first automated conversation demonstrates the technical implementation in a real conversational context with the use of artificially intelligent bot.

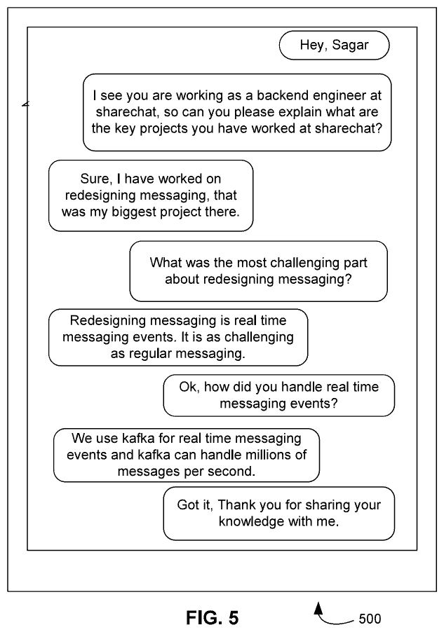

FIG. 5 is a user interface 500 that illustrates a second automated conversation between the artificially intelligent bot 110 and a second user 102B according to some embodiments herein. The artificially intelligent bot 110 starts the automated conversation by greeting the user 102B with a salutation and a first question. Specifically, the question pertains to the role of the user 102B as a backend engineer at ShareChat. The artificially intelligent bot 110 inquires, “Hey Sagar, I see you are working as a backend engineer at ShareChat, so can you please explain what are the key projects you have worked on at ShareChat?” This first question is dynamically generated based on analyzing at least one of the resume of the user 102B or the job description associated with the automated conversation.

In response to the question, the user 102B provides details about their work at ShareChat, specifically mentioning, “Sure, I have worked on redesigning messaging; that was my biggest project there.” The artificially intelligent bot 110, in real-time, analyzes this response to determine whether it falls within the content boundary of the first state. In this instance, the response remains within the content boundary.

Building on the response, the artificially intelligent bot 110 generates a follow-up question. The follow-up question is tailored to the context and content of the previous response. The artificially intelligent bot 110 asks, “What was the most challenging part about redesigning messaging?”

The user 102B responds, stating, “Redesigning messaging is real-time messaging events. It is as challenging as regular messaging.” The artificially intelligent bot 110, in real-time, analyzes this response, which falls within the content boundary. Subsequently, the bot generates another follow-up question “Ok, how did you handle real-time messaging events?” This follow-up question is generated based on the context and content of the previous response. The user 102B provides further information, stating, “We use Kafka for real-time messaging events, and Kafka can handle millions of messages per second.” The artificially intelligent bot 110 determines that the response is within the content boundary and generates a closing message to conclude the conversation. The closing message signifies that the required information related to the job profile of the user 102B has been obtained, and it states, “Got it, Thank you for sharing your knowledge with me.”

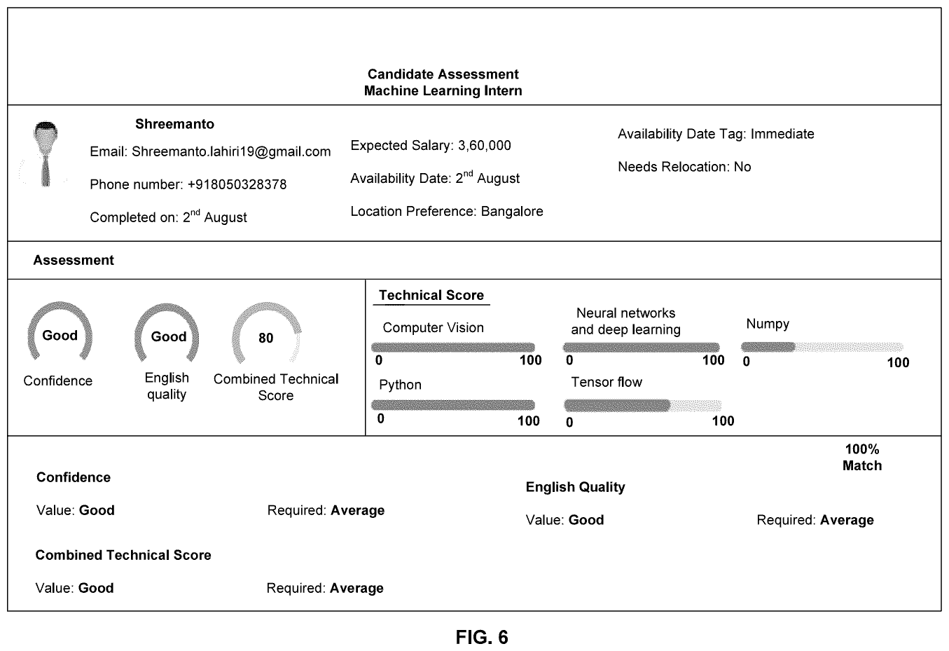

FIG. 6 is an exemplary view of an evaluation report of a user according to some embodiment herein. The evaluation report is generated by evaluating the user on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter.

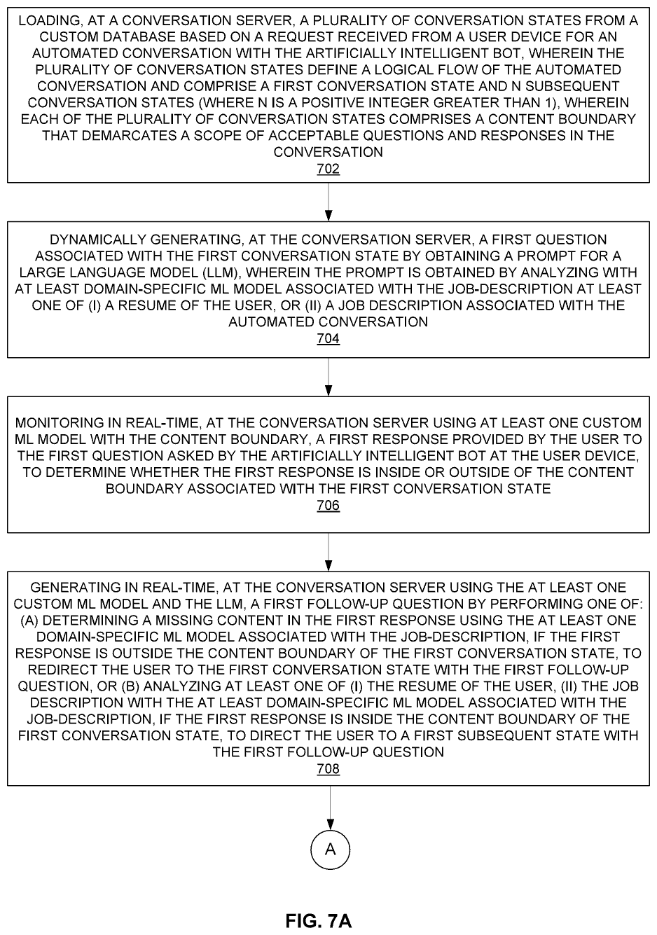

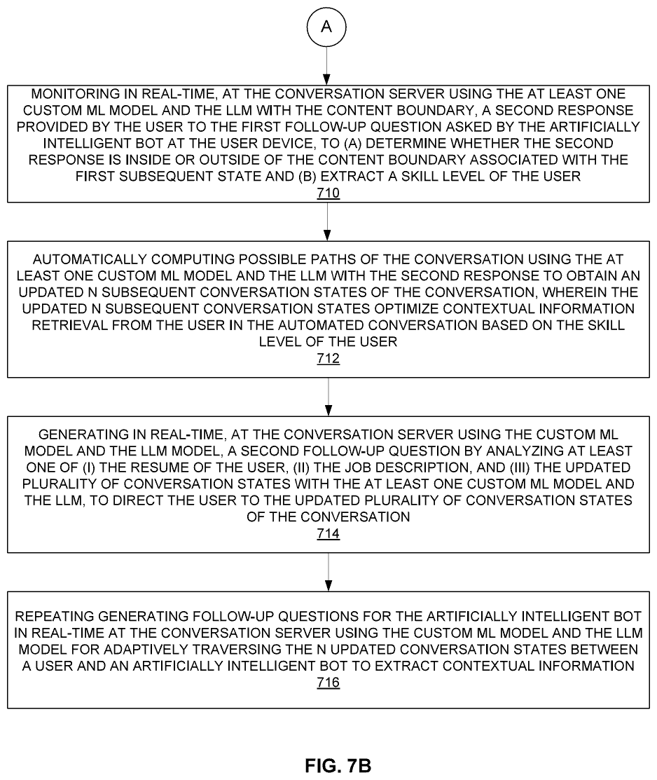

FIGS. 7A and 7B are flow diagrams of a method for adaptively traversing conversation states using conversational AI to extract contextual information according to some embodiments herein. At step 702, the method includes loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation. At step 704, the method includes dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description. At step 706, the method includes monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state. At step 708, the method includes generating in real-time, at the conversation server using the at least one custom ML model and the LLM, a first follow-up question by performing one of: (a) determining a missing content in the first response using the at least one domain-specific ML model associated with the job-description, if the first response is outside the content boundary of the first conversation state, to redirect the user to the first conversation state with the first follow-up question, or (b) analyzing at least one of (i) the resume of the user, (ii) the job description with the at least domain-specific ML model associated with the job-description, if the first response is inside the content boundary of the first conversation state, to direct the user to a first subsequent state with the first follow-up question. At step 710, the method includes monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user. At step 712, the method includes automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user. At step 714, the method includes generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation. At step 716, the method includes repeating generating follow-up questions for the artificially intelligent bot in real-time at the conversation server using the custom ML model and the LLM for adaptively traversing the N updated conversation states between the user and the artificially intelligent bot to extract contextual information.

The method is of advantage that the method optimizes retrieval of contextual information during automated conversations between users and artificially intelligent bots by dynamically updating conversation states. The method utilizes content boundary to monitor responses of the user in real-time and detect when the user provides incomplete information, responds ambiguously, or changes the topic. When such instances are detected, the custom machine learning models generate follow-up questions in real-time that guide the user back to the intended question or topic.

Further, the method is of advantage that the method minimizes latency in automated conversations. By integrating general-purpose Large Language Models (LLMs) with custom ML models, the method optimally combines the strengths of both. The method enables rapid and contextually precise computation of possible conversation paths at each user response. By utilizing the custom ML models, the method computes possible paths of the conversation to dynamically update the conversation states, thus eliminating unnecessary detours and maximizing retrieval of contextual information from the user. The result is an efficient automated conversation that takes less time to retrieve contextual information from the user and enhances efficiency and effectiveness of conversational AI driven interactions.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

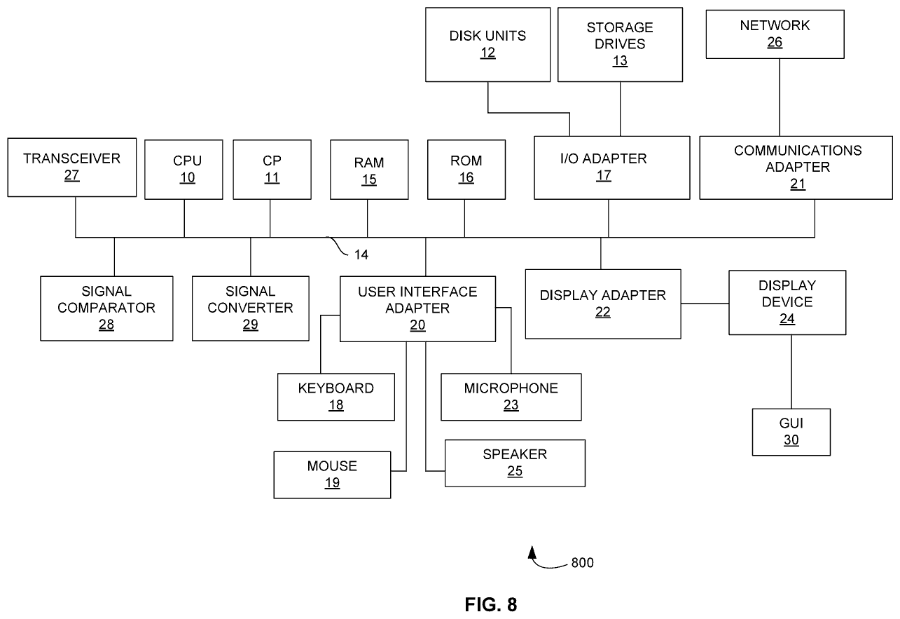

A representative hardware environment for practicing the embodiments herein is depicted in FIG. 8, with reference to FIGS. 1 through 7A and 7B. This schematic drawing illustrates a hardware configuration of a server 108 or a computer system or a computing device in accordance with the embodiments herein. The system includes at least one processing device CPU 10 that may be interconnected via system bus 14 to various devices such as a random-access memory (RAM) 15, read-only memory (ROM) 17, and an input/output (I/O) adapter 17. The I/O adapter 17 can connect to peripheral devices, such as disk units 12 and program storage devices 13 that are readable by the system. The system can read the inventive instructions on the program storage devices 13 and follow these instructions to execute the methodology of the embodiments herein. The system further includes a user interface adapter 20 that connects a keyboard 18, mouse 19, speaker 25, microphone 23, and other user interface devices such as a touch screen device (not shown) to the bus 14 to gather user input. Additionally, a communication adapter 21 connects the bus 14 to a data processing network 42, and a display adapter 22 connects the bus 14 to a display device 24, which provides a graphical user interface (GUI) 30 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for adaptively traversing conversation states between a user and an artificially intelligent bot to extract contextual information:
loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation;
dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description;
monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state;
generating in real-time, at the conversation server using the at least one custom ML model and the LLM, a first follow-up question by performing one of:
(a) determining a missing content in the first response using the at least one domain-specific ML model associated with the job-description, if the first response is outside the content boundary of the first conversation state, to redirect the user to the first conversation state with the first follow-up question, or
(b) analyzing at least one of (i) the resume of the user, (ii) the job description with the at least domain-specific ML model associated with the job-description, if the first response is inside the content boundary of the first conversation state, to direct the user to a first subsequent state with the first follow-up question;
monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user;
automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user;
generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation; and
repeating generating follow-up questions for the artificially intelligent bot in real-time at the conversation server using the custom ML model and the LLM for adaptively traversing the N updated conversation states between the user and the artificially intelligent bot to extract contextual information.

2. The processor-implemented method of claim 1, further comprising re-training the at least one custom ML model by:
(i) tagging content data associated with the responses; and
(ii) improving a classification threshold by identifying a pattern in the content of the user using unsupervised learning to re-train the at least one custom ML models.

3. The processor-implemented method of claim 1, further comprising evaluating the user on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter.

4. The processor-implemented method of claim 1, further comprising enabling the user to practice the automated conversation, wherein the processor generates new follow-up questions based on the first response provided by the user for the first question.

5. The processor-implemented method of claim 1, further comprising simulating the automated conversation based on (a) a selected job description that is selected by the user from a list of job descriptions and (b) a resume provided by the user.

6. The processor-implemented method of claim 1, further comprising monitoring a response to a theoretical question by providing content of a standard answer to at least one custom ML model.

7. The processor-implemented method of claim 1, further comprising monitoring a response of a work experience related question by providing (a) a project detail from the resume, and (b) a template of questions associated a role associated with the automated interview.

8. A system for adaptively generating voice-based follow-up questions based on a state of a conversation in an automated interview using custom machine learning (ML) models with large language models, comprising:
a memory that stores a set of instructions; and
a processor that is configured to execute the set of instructions for:
loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation;
dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description;
monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state;
generating in real-time, at the conversation server using the at least one custom ML model and the LLM, a first follow-up question by performing one of:
(a) determining a missing content in the first response using the at least one domain-specific ML model associated with the job-description, if the first response is outside the content boundary of the first conversation state, to redirect the user to the first conversation state with the first follow-up question, or
(b) analyzing at least one of (i) the resume of the user, (ii) the job description with the at least domain-specific ML model associated with the job-description, if the first response is inside the content boundary of the first conversation state, to direct the user to a first subsequent state with the first follow-up question;
monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user;
automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user;
generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation; and
repeating generating follow-up questions for the artificially intelligent bot in real-time at the conversation server using the custom ML model and the LLM for adaptively traversing the N updated conversation states between the user and the artificially intelligent bot to extract contextual information.

9. The system of claim 8, wherein the processor is configured to re-train the at least one custom ML model by:
(i) tagging content data associated with the responses; and
(ii) improving a classification threshold by identifying a pattern in the content of the user using unsupervised learning to re-train the at least one custom ML models.

10. The system of claim 8, wherein the processor is configured to evaluate the user on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter.

11. The system of claim 8, wherein the processor is configured to enable the user to practice the automated conversation, wherein the processor generates new follow-up questions based on the first response provided by the user for the first question.

12. The system of claim 8, wherein the processor is configured to simulate the automated conversation based on (a) a selected job description that is selected by the user from a list of job descriptions and (b) a resume provided by the user.

13. The system of claim 8, wherein the processor is configured to monitor a response to a theoretical question by providing content of a standard answer to at least one custom ML model.

14. The system of claim 8, wherein the processor is configured to monitor a response of a work experience related question by providing (a) a project detail from the resume, and (b) a template of questions associated a role associated with the automated interview.

15. A non-transitory computer-readable storage medium storing a sequence of instructions, which when executed by one or more processors, causes deriving a subset from a dataset based on proclivity of entity devices towards a category, comprising:
loading, at a conversation server, a plurality of conversation states from a custom database based on a request received from a user device for an automated conversation with the artificially intelligent bot, wherein the plurality of conversation states define a logical flow of the automated conversation and comprise a first conversation state and N subsequent conversation states (where N is a positive integer greater than 1), wherein each of the plurality of conversation states comprises a content boundary that demarcates a scope of acceptable questions and responses in the conversation;
dynamically generating, at the conversation server, a first question associated with the first conversation state by obtaining a prompt for a large language model (LLM), wherein the prompt is obtained by analyzing at least one of (i) a resume of the user, or (ii) a job description associated with the automated conversation with at least domain-specific ML model associated with the job-description;
monitoring in real-time, at the conversation server using at least one custom ML model with the content boundary, a first response provided by the user to the first question asked by the artificially intelligent bot at the user device, to determine whether the first response is inside or outside of the content boundary associated with the first conversation state;
generating in real-time, at the conversation server using the at least one custom ML model and the LLM, a first follow-up question by performing one of:
(a) determining a missing content in the first response using the at least one domain-specific ML model associated with the job-description, if the first response is outside the content boundary of the first conversation state, to redirect the user to the first conversation state with the first follow-up question, or
(b) analyzing at least one of (i) the resume of the user, (ii) the job description with the at least domain-specific ML model associated with the job-description, if the first response is inside the content boundary of the first conversation state, to direct the user to a first subsequent state with the first follow-up question;
monitoring in real-time, at the conversation server using the at least one custom ML model and the LLM with the content boundary, a second response provided by the user to the first follow-up question asked by the artificially intelligent bot at the user device, to (a) determine whether the second response is inside or outside of the content boundary associated with the first subsequent state and (b) extract a skill level of the user;
automatically computing possible paths of the conversation using the at least one custom ML model and the LLM with the second response to obtain an updated N subsequent conversation states of the conversation, wherein the updated N subsequent conversation states optimize contextual information retrieval from the user in the automated conversation based on the skill level of the user;
generating in real-time, at the conversation server using the custom ML model and the LLM, a second follow-up question by analyzing at least one of (i) the resume of the user, (ii) the job description, and (iii) the updated N subsequent conversation states with the at least one custom ML model and the LLM, to direct the user to the updated N subsequent conversation states of the conversation; and
repeating generating follow-up questions for the artificially intelligent bot in real-time at the conversation server using the custom ML model and the LLM for adaptively traversing the N updated conversation states between the user and the artificially intelligent bot to extract contextual information.

16. The non-transitory computer readable storage medium storing a sequence of instructions of claim 15, further comprising re-training the at least one custom ML model by:
(i) tagging content data associated with the responses; and
(ii) improving a classification threshold by identifying a pattern in the content of the user using unsupervised learning to re-train the at least one custom ML models.

17. The non-transitory computer readable storage medium storing a sequence of instructions of claim 15, further comprising evaluating the user on a plurality of parameters associated with the skills of the user by extracting at least one of a contextual feature or a vocal feature from responses provided by the user, wherein the plurality of parameters comprise at least one of a response duration parameter, a sentiment parameter, a personality parameter, a meaningfulness parameter, a grammar parameter, a filler word usage parameter, or a monosyllabic answer parameter.

18. The non-transitory computer readable storage medium storing a sequence of instructions of claim 15, further comprising enabling the user to practice the automated conversation, wherein the processor generates new follow-up questions based on the first response provided by the user for the first question.

19. The non-transitory computer readable storage medium storing a sequence of instructions of claim 15, further comprising, simulating the automated conversation based on (a) a selected job description that is selected by the user from a list of job descriptions and (b) a resume provided by the user.

20. The non-transitory computer readable storage medium storing a sequence of instructions of claim 15, further comprising further comprising (i) monitoring a response to a theoretical question by providing content of a standard answer to at least one custom ML model, and (ii) monitoring a response of a work experience related question by providing (a) a project detail from the resume, and (b) a template of questions associated a role associated with the automated interview.
